(19) United States
(12) Patent Application Publication
(10) Pub. No.: US 2025/0292318 A1
(43) Pub. Date: Sep. 18, 2025

(54) CARD TRANSACTION ANOMALY DETECTION

(71) Applicant: JPMorgan Chase Bank, N.A., New York, NY (US)

(72) Inventors: Steve M. Piatt, Dublin, OH (US); Benjamin Williams, Columbus, OH (US); Maxime Labonne, London (GB)

(73) Assignee: JPMorgan Chase Bank, N.A., New York, NY (US)

(21) Appl. No.: 19/075,020

(22) Filed: Mar. 10, 2025

Related U.S. Application Data
(60) Provisional application No. 63/566,771, filed on Mar. 18, 2024.

(51) Int. Cl. G06Q 40/02

(52) U.S. Cl. CPC G06Q 40/02

(57) ABSTRACT

Provided is a system and method for identifying anomaly patterns for card transactions within a consumer banking environment that includes retrieving, card transaction data, filtering and storing the debit card transaction data as raw data, processing the raw data in real-time, by detecting card transaction declines within the raw data, identifying, in real-time via a machine learning model, anomaly patterns associated with the card transaction declines detected; and generating at least one graphical illustration associated with the anomaly patterns identified, to be accessible via a user interface.

### CROSS-REFERENCE TO RELATED APPLICATIONS

This application claims benefit to U.S. Provisional Patent Application 63/566,771 filed Mar. 18, 2024, the disclosure of which is incorporated herein in its entirety, by reference.

### FIELD OF TECHNOLOGY

The present disclosure relates generally to identifying patterns of card transaction declines representing anomalies and training a machine learning (ML) model to identify these patterns.

### BACKGROUND

In the consumer banking environment, there are multiple entry points into transaction middleware systems that occur per second such as point of sales (POS) and ATM transactions. Many consumers utilize their debit and credit cards to conduct various types of transactions, for example, at a gas station or restaurant. These card transactions occur at a rate of approximately 800 to 1,000 transactions per second or approximately 50 million per day. Sometimes erroneous declines occur during these card transactions due to either a banking network error or an error at the particular merchant's end. On the banking network end, it can be difficult to manually detect anomaly patterns that occur based on these types of erroneous card declines given the scale at which card transactions are processed daily.

As such, a need exists for a system and method to effectively detect card transaction declines and to identify any anomaly patterns, to be able to provide alerts at the banking network end or to address the issue occurring at the merchant end.

### SUMMARY

The present disclosure, through one or more of its various aspects, embodiments, and/or specific features or sub-components, provides various systems, servers, devices, methods, media, programs, and platforms for monitoring and detecting card decline anomalies within a consumer banking environment.

Under certain circumstances, embodiments of the present disclosure provide a system and method for identifying anomaly patterns for card transactions within a consumer banking environment that includes retrieving, card transaction data, filtering and storing the card transaction data as raw data, processing the raw data on a predetermined basis, by detecting card transaction declines within the raw data, identifying, via a machine learning model, anomaly patterns associated with the card transaction declines detected, and generating at least one graphical illustration associated with the anomaly patterns identified, to be accessible via a user interface.

In yet another embodiment, a tangible computer-readable medium having stored thereon, computer executable instructions that, if executed by a computing device, cause the computing device to perform the above-mentioned method.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1A is a schematic of a consumer banking environment according to one or more embodiments of the present disclosure.

FIG. 1B is a more detailed illustration of a first section shown in FIG. 1A illustrating the on-premise flow of transaction data according to one or more embodiments of the present disclosure.

FIG. 1C is a more detailed illustration of a second section shown in FIG. 1A illustrating cloud architecture for processing the flow of data received from on-premises according to one or more embodiments of the present disclosure.

FIG. 2 is a flow diagram showing an anomaly detection method within a model including a process flow that occurs during a run of the model for detecting card transaction anomalies within the consumer banking environment, according to one or more embodiments of the present disclosure.

FIGS. 3A and 3B illustrate graphical outputs at a user interface shown in FIG. 1A, by which a user can retrieve anomaly data, according to one or more embodiments of the present disclosure.

FIG. 4 illustrates an exemplary environment in which various embodiments of the present disclosure can be implemented.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

Embodiments of the present disclosure will be described herein with reference to a consumer banking environment. Typically, in a consumer banking environment, the banking system retrieves transaction files each business day. The method of the present disclosure enables the banking system to operate in real-time whereby transactions and associated transactional data are captured and processed in real-time to track anomalies associated with any transactional data (e.g., credit card and debit card declines) to thereby improve the end customer experience. Although the method and system are illustrated herein using card transactions, embodiments of the present disclosure can also be implemented with any type of transactional data.

The system performs the method of monitoring and detecting card decline anomalies across various payment channels and reporting these anomalies and associated information to a back-end user (e.g., banking system operations personnel) via graphical outputs at a user interface (UI). The associated information may include decline metrices associated with POS transactions including the transaction type, payment network, bin range, and a determined threshold for anomalous declines as a percentage (%) of declines, for example. The embodiments also provide a predictive model using an ML algorithm to alert a user when a payment channel or a combination of payment channels is exhibiting anomalous decline behavior. According to some embodiments, the ML algorithm employs parallel processing, distributing the data across multiple processing units to process the data in real-time.

According to the embodiments, a model is employed to automate the process by sifting and filtering through all the data, searching for and detecting patterns, and alerting a user of the detected patterns so that over time historical data can be used to perform corrective and/or predictive action.

Within a banking network, at given times there may be occasional spikes in card transaction declines and it can be difficult to determine whether these card transaction declines are legitimate. The methods and systems described herein are capable of identifying anomaly patterns to quickly eliminate erroneous card declines in real-time based on historical data (e.g., from prior days). The anomalies can occur based on a problem with a mandate or change to a type of transaction on a payment channel end e.g., on Visa channel, expired keys, or an issue at a particular merchant. For example, anomalies may occur if new point of sale devices are being used by merchants without the banking system's knowledge, bins that have not been registered in transaction middleware system, updates to mandates occur but the payment channels fail to abide by changes at their side, if there are transaction middleware system issues that occur downstream, expired tokens/keys in digital wallet transactions, or online transaction issues impacting customers.

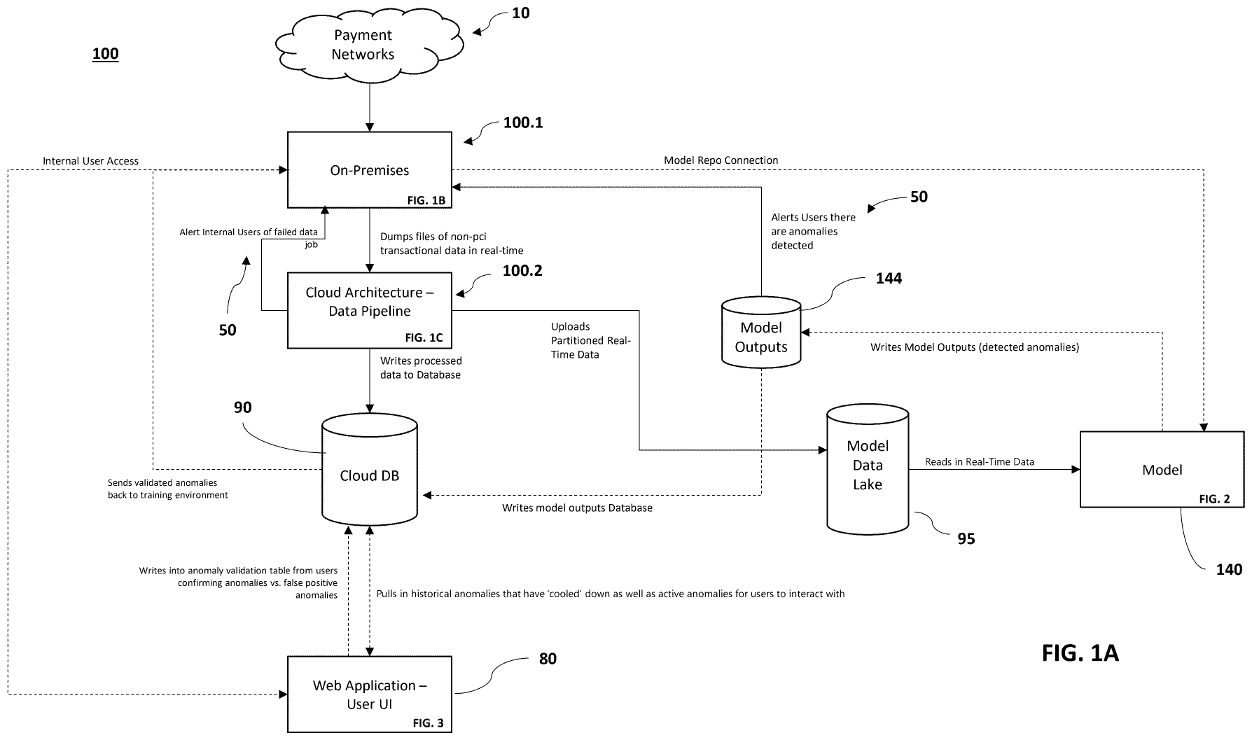

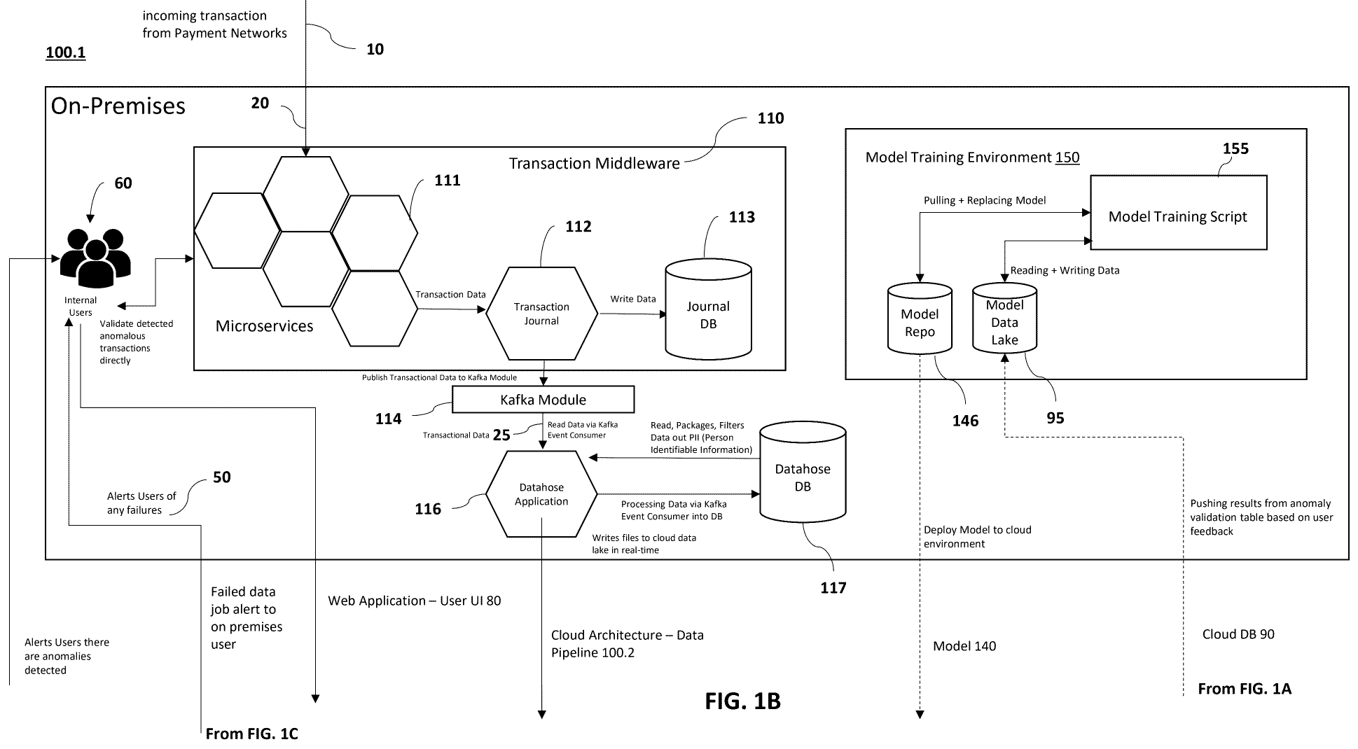

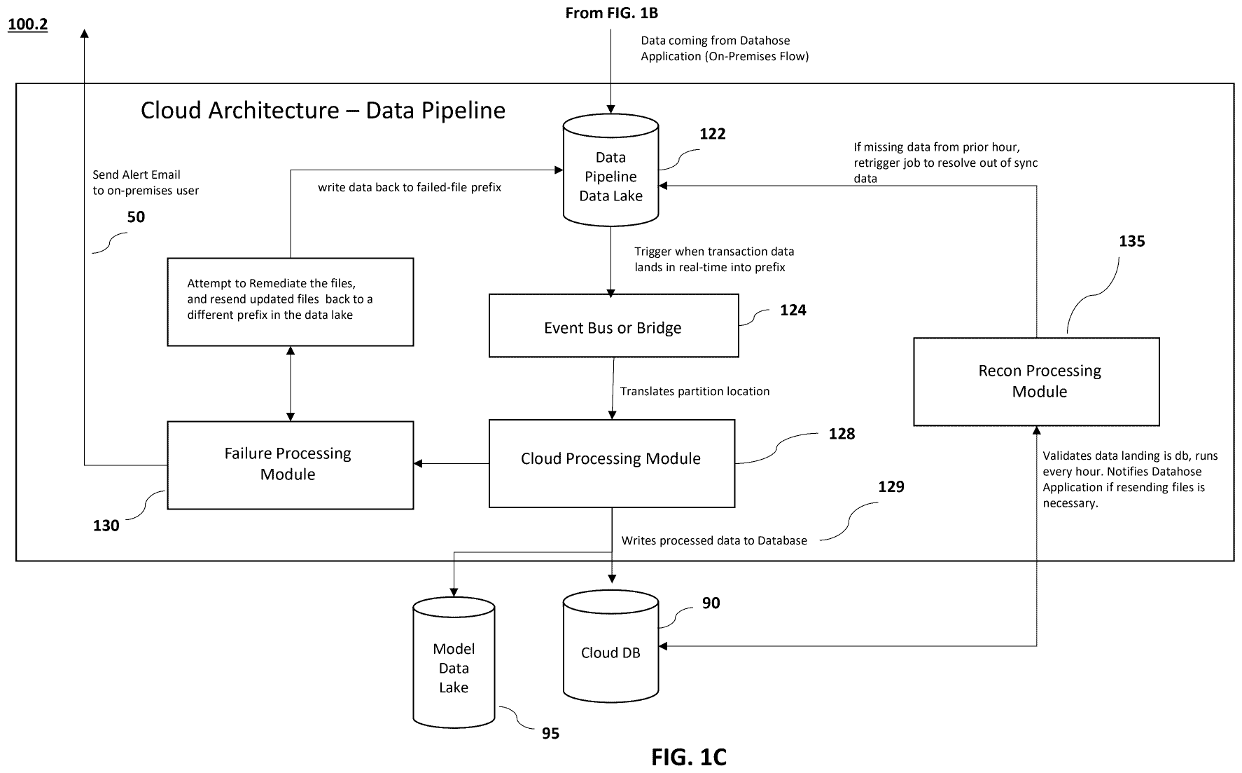

As shown in FIG. 1A, a consumer banking environment 100 is provided. The environment 100 includes a cloud environment according to embodiments of the present disclosure. For purposes of illustrative clarity, the consumer banking environment 100 is partitioned as a first section 100.1, depicted in greater detail in FIG. 1B. A second section 100.2 of the environment 100 is depicted in greater detail in FIG. 1C.

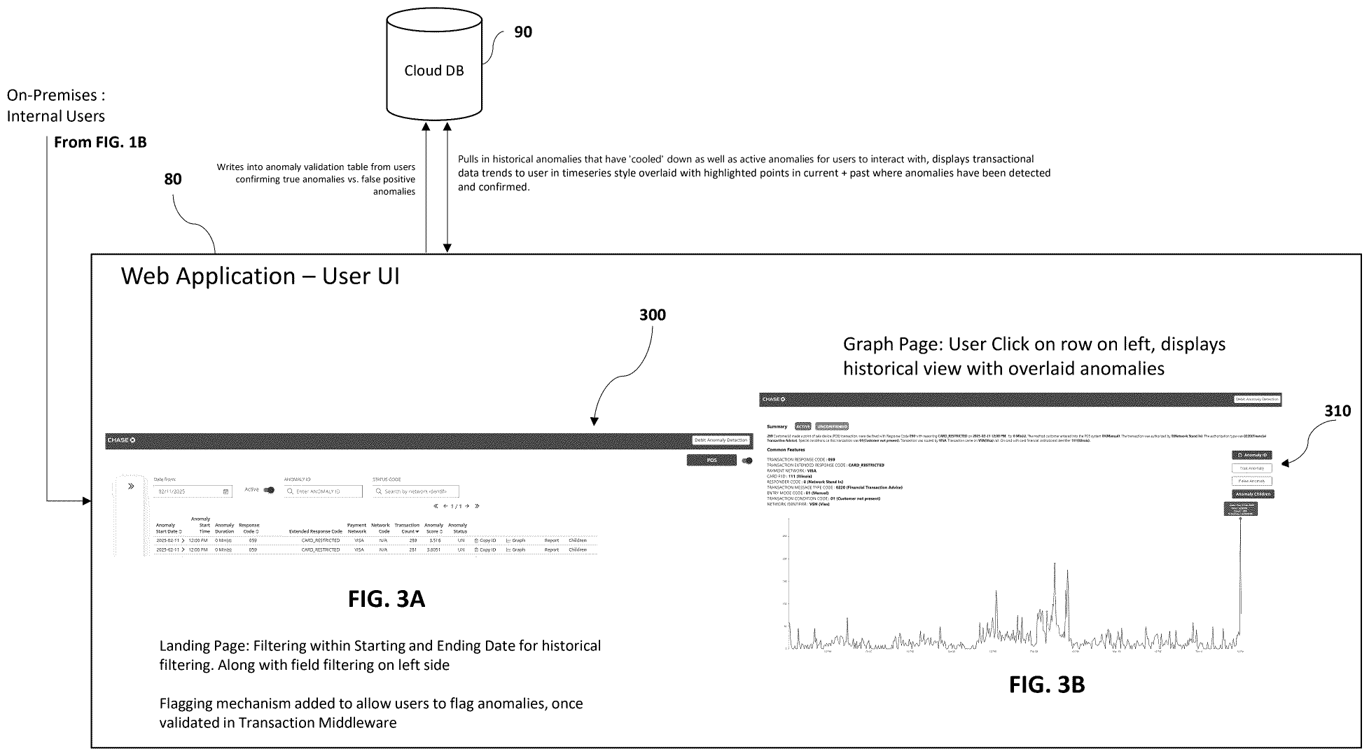

As further shown in FIG. 1A, transactional data is received on-premises at section 100.1 from various payment networks 10. The transactional data is processed and sent through a data pipeline within a cloud environment at section 100.2 for further processing. Non PCI data may be dumped in real-time. The non PCI data includes date/time of transaction, merchant information, type of transaction, bin number, decline codes associated with reason the card transaction was declined. If any failed data exists, an alert 50 is sent via an event bus or bridge back on-premises to users 60 (depicted in FIG. 1B) at the banking system. The processed data from section 100.2 is stored within a cloud database 90 for further processing. The stored data may be retrieved via a model learning (ML) feedback loop (as depicted by a dashed line), by a user interface 80 for displaying anomaly data associated with the transactional data. Historical anomalies that have “cooled” down (i.e., are no longer active), as well as active anomalies are pulled in for users to interact with. In addition, the stored data may be sent through a data pipeline within the cloud architecture for the data to be consumed by model 140 in real-time once placed in partitions in the model data lake 95 Model 140 outputs via the ML feedback loop, model outputs including detected anomaly data to be stored in an associated model database 144 and the model outputs from the model database 144 can also be written back to the cloud database 90. Alerts 50 are also sent to the users 60 at the user interface 80 when anomaly data is written to the model database 144, to be accessed and observed and to pursue remedies to address the issues. The users 60 can validate detected anomalous transactions directly (as depicted in FIG. 1B and further discussed in FIGS. 3A and 3B below). Also shown in FIG. 1A, a user has internal user access to the on-premises data pipeline in section 100.1 and to the cloud database 90 via the user interface 80. A model repo connection of a model repo module 146 (depicted in FIG. 1B) is provided for connecting between the on-premises pipeline in section 100.1 and the model 140 as further part of the ML feedback loop. Further details of FIG. 1A are to be discussed below with reference to FIGS. 1B and 1C.

As shown, FIG. 1B is a more detailed illustration of the first section 100.1 shown in FIG. 1A, illustrating the on-premise flow of transaction data according to one or more embodiments of the present disclosure.

As shown in FIG. 1B, on-premises at a banking system, transaction middleware 110 is provided and may include microservices 111, and a transaction journal 112 and a journal database 113 for processing card transactional data within the banking system, transaction middleware 110 processes card transactions 20, such as credit and debit card transactions from Visa® and Mastercard® payment networks 10 and other payment networks. The transaction middleware 110 retrieves these card transactions 20 from a merchant's network (not shown).

The transaction middleware 110 filters the card transactions 20 and sends card transactional data associated with the card transactions 20 to a transactional journal 112 and the associated transactional data is written to a journal database 116. The transactional data is then published to a transaction collecting module (e.g. a Kafka module 114) for real-time and batch data processing where the select card transactions 25 are read via a Kafka event consumer from the transaction journal 111 and input through a datahose application 116 and data processed by the Kafka event consumer is stored in a datahose database 117. Then the data from the datahose database 117 is read and filtered to remove personal identifiable information (PII) data and then sent back to the datahose application 116 for further processing. According to embodiments of the present disclosure, datahose application 116 is written in real-time to a data pipeline data lake 122 in the cloud environment in section 100.2 for further processing.

FIG. 1C is a more detailed illustration of the second section 100.2 shown in FIG. 1A illustrating cloud architecture for processing the flow of data received from on-premises according to one or more embodiments of the present disclosure.

As shown in FIG. 1C, as mentioned above, the raw data associated with card transactional data 25 is input into data pipeline data lake 122 (e.g., a cloud object storage). An event bus (or bridge) 124 performs a scanning operation to detect when raw data has been input into data pipeline data lake 122. Correspondingly, the event bus 124 triggers a partitioning method to sort the data received. This processing determines partition location(s) of the declined card transactions via a data processing module (e.g., cloud processing module 128) The cloud processing module 128 is configured to perform the main extract transform and load (ETL) process flow within the consumer banking environment 100. This process flow takes parquet files with POS transactional data received from an upstream at the on-premises application in section 100.1 and processes and cleans the file contents, and inserts the processed data 129 into the cloud database 90. The process flow also checks for any file processing failures and triggers a failure flow within a failure processing module 130 (to be discussed below) if there is a failure status in any of the ETL job runs.

Components within the cloud processing module 128 can be implemented as a part of a cloud storage environment (e.g., AWS® cloud storage) or the like in accordance with the embodiments. The processed data 129 associated with the declined card transactions includes, for example, the merchant location, time/date information, consumer banking data, transaction type, payment network and associated channel(s) and any anomalies detected.

When a failure occurs during the processing of the data via the process flow within the cloud processing module 128, such as the process fails, times out or stops, the associated data is processed via a failed data process flow 130 and an alert/notification 50 is generated and sent to users 60 via a UI 110 on-premises. An attempt is made via a failure processing module 130 to remediate the files and resend update files back to a different prefix within the database data lake 122. A recon processing module 135 may also be implemented to validate the data landing in the data pipeline data lake 122. That is, that the raw data is being retrieved on a predetermined basis (e.g., 4 times per hour) and re-triggers system logic to re-run the raw data at the data pipeline data lake 122, to determine whether there are any missed declined card transactions that need to be processed to resolve out of sync data. According to this embodiment, for example approximately every hour or so, the data pipeline data lake 122 will be traced to determine whether the raw data is being processed accurately and if not, the process flow 128 may be repeated as needed.

Further, in FIG. 1C, the processed data 129 can be generated into graphical outputs/illustrations (e.g., tables/charts) and retrievable at the user interface 80. An example of these illustrations are depicted in FIGS. 3A and 3B which respectively display the transactions associated with the processed data 128 in chart 300 and the associated anomaly as shown in graph 310.

Referring back to FIG. 1B, a model training environment 150 is hosted within a cloud storage container or database and includes model transcripts 155 and the model data lake 95 and the model repo module 146. According to one embodiment, the card transactions 20 can be sent directly to the model training environment 150 on a periodic basis e.g., approximately every 15 minutes from on-premises shown in FIG. 1A. This data is unaggregated data from the transaction middleware 110. The data is aggregated and fed into the training environment 150. The model training environment 150 dynamically loads a file associated with the aggregated data from the transaction middleware 110 and a file associated with the processed data 129 from the data pipeline data lake 122 and stores it as historical data within the model training environment 150. Further, in the ML feedback loop, the model repo module 146 is where a version of the model 140 is stored so that latest version versus previous versions are tracked. The model repo module 146 pulls and replaces models 140 from within the model training environment 155 and deploy the model 140 into the cloud environment. In addition, data from the cloud database 90 including results from an anomaly validation table (as depicted in FIG. 3A) based on user feedback is pushed into the model data lake 95. Validated anomalies are also sent back into the training environment 150 for further processing.

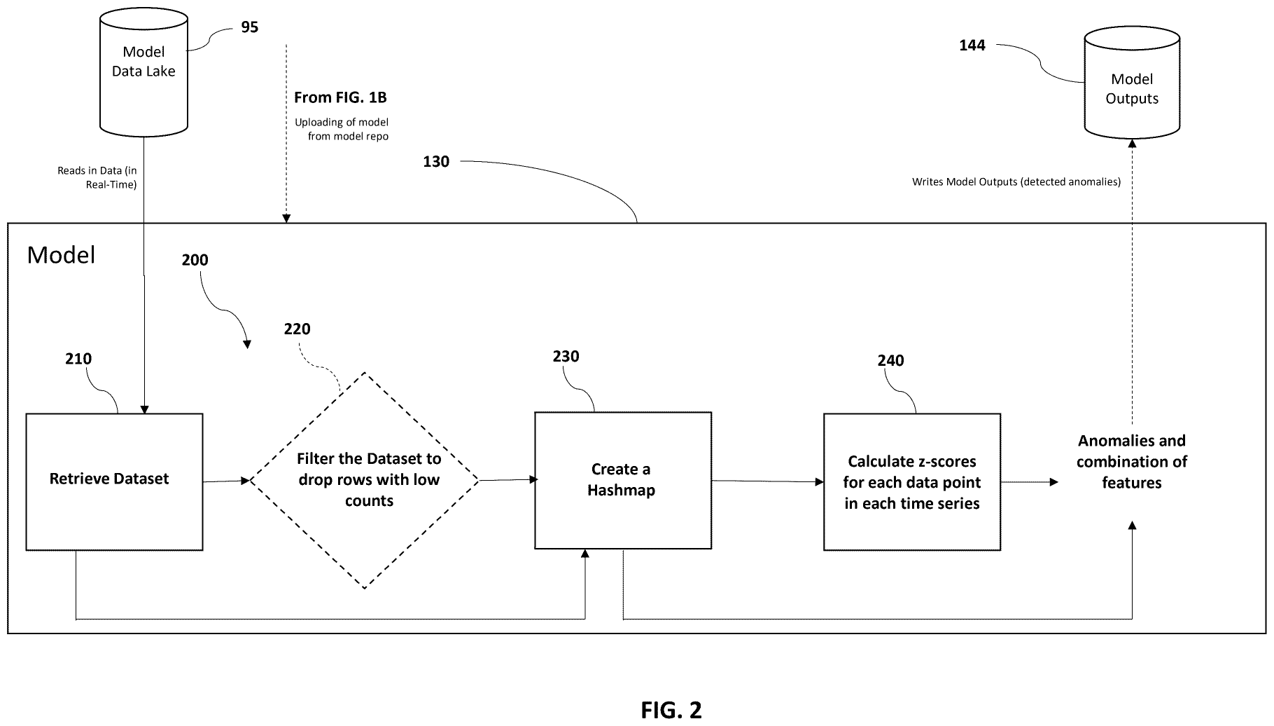

In FIG. 2 illustrates an anomaly detection method 200 for detecting declined card transaction anomalies within the consumer banking environment 100. In FIG. 2, the anomaly detection method 200 performs anomaly detection of the card transaction by use of an anomaly algorithm.

As shown in FIG. 2, the method 200, begins at operation 210 where the data set is retrieved from the banking transaction processing system 100. The data set is retrieved in real-time according to embodiments of the present disclosure. According to one embodiment, the process continues to operation 220 where the data set is filtered to drop rows of data with low transaction counts. The process continues from either operation 210 or operation 220 to operation 230, where a hashmap is created to index unique combinations of features observed in the dataset. The features describe the key paths in which a card transaction can occur. These features correspond to the fields on the transactional table. A single unique path is a feature and value (field+value) combination that results from a card transaction. For example, if a card is declined for insufficient funds, the field=transaction_response_code and the value=76, when it is used at a particular merchant. The field may be associated with “merchant” while the value may be associated with the name of the merchant. The hashmap may also include unique identifiers (ID) generated in association with the transaction type (e.g., Visa® or MasterCard® transaction).

According to an alternative embodiment, a python generator may be created with the following parameters including, for example, a hash, a list of indexes or a list of target values to organize all the data for fast indexing.

The process continues to operation 240 where an anomaly detection model object can be processed for each unique combination in the data set by calculating a standardized score (e.g., a z-score) for each data point in the dataset in each time series of data using an anomaly algorithm. The anomaly detection algorithm dynamically detects peaks and valleys in each time series of data. The standardized score can be used to detect anomalies such that any score that is within a predetermined threshold, outside of the standardized score, will be considered an anomaly. By way of example only and not limitation, there are four (4) different types of anomaly algorithms that can be implemented according to one or more embodiments of the present disclosure. The different types include a fast z-score algorithm, an exponential weighted moving average model (EWM) z-score, a median absolute deviation (MAD) z-score and a seasonal and trend decomposition using Loess (STL) z-score.

The fast z-score algorithm as shown below:

$${z}_{1} = \frac{{χ}_{i} - μ}{σ}$$

Where z₁ is a fast z-score which is computed for each data point in a time series and a predetermined threshold (r) is set for example at a standard deviation of 3.5 so for every data point χᵢ where z₁ is greater than or equal to r or less than or equal to τ then data point χᵢ is considered an anomaly and the corresponding subset of features are extracted using a hashmap (as referenced in FIG. 2).

According to another embodiment, the EWM z-score algorithm is implemented whereby instead of directly computing the z-scores (z₁) for each data point as shown above, an exponential weighted moving average of these values is computed to gain more information about past values of each data point based on a predetermined time period (e.g., five weeks) and then the z-scores are computed for each of these post exponential weighted moving average (EWMA) values. The EWMA is computed using the following:

$$length = data . shape [ 0 ]$$

$$alpha = 2 / ( window + 1. )$$

$$alpha\_rev = 1 - alpha$$

$$pows = alpha\_rev ** ( np . arange ( length + 1 ) )$$

$$scale\_arr = 1 / pows [ : - 1$$

$$offset = data [ 0 ] * pows [ 1 : ]$$

$$pw = alpha * alpha\_rev ** ( length - 1 )$$

$$mult = data * pw * scale\_arr$$

$$cumsums = mult . cumsum ( )$$

$$out = offset + cumsums * scale\_arr [ \text{::} - 1 ]$$

$$return out$$

$${EWMA}_{t} = α * {r}_{t} + ( 1 - α ) * {EWMA}_{t - 1}$$

According to another embodiment, the MAD z-score algorithm is implemented whereby the standard deviation is replaced with a median absolute deviation defined as MAD=median (|Xᵢ−X∥ where X=median (X).

According to yet another embodiment the STL z-score algorithm is implemented whereby seasonal and trend decomposition can be used to compute the z-scores on the residuals instead of the original data point values. The decomposition removes seasonal and trends from the times series (e.g., holidays).

For every data point with a z-score greater than or less than the threshold and within a predetermined time period (e.g., less than five weeks), it is flagged as an anomaly and stores as an anomaly object in a list. According to embodiments of the present disclosure, a z-score of zero means that the data point corresponds to the mean of the distribution, however if the z-score is higher than 3.5, for example, it is an anomaly.

FIGS. 3A and 3B illustrate graphical outputs at the user interface 80 shown in FIG. 1A, by which a user can retrieve anomaly data, according to one or more embodiments of the present disclosure. As shown in FIGS. 3A and 3B, users on user interface 80 receive alerts/notifications 50 indicative of any anomalies detected over a predetermined period of time. The predetermined period of time can be daily, weekly or any specified time period such as a two (2) day period. This data can be data that is retrieved from data storage 90 as the result of a user-based query requested by a user from the user interface 80. The data includes historical anomalies that have cooled down (turned into inactive anomalies) as well as active anomalies for users to interact with, and displays transactional data trends to the users in timeseries style overlaid with highlighted points in current+past where anomalies have been detected and confirmed. According to embodiments of the present disclosure, active anomalies refers to currently active anomalies being detected continuously over a real-time period, while cooling down refers to anomalies that had been detected, but have not continued increasing for approximately the last 45 minutes; and inactive anomalies refers to anomalies that had been detected to then not been continuously detected since it past a cool down period (e.g., approximately 45 minutes). Users access the anomaly data via the user interface 80 as shown. The users are able to view the chart 300 on a landing page at the user interface 80 as shown in FIG. 3A, and can filter the anomaly data. If desired, the user can select starting and ending dates for historical filtering or perform field filtering.

When a user selects one of the anomaly records (e.g., user clicks on the graph button) on the chart 300, a graph 310 as shown in FIG. 3B populates showing the anomaly data associated with an anomaly event and a flagging mechanism enables users to flag anomalies as true anomalies or false anomalies once validated in transaction middleware 110 (as depicted in FIG. 1B). According to an embodiment of the present disclosure a feedback loop is implemented with the true anomalies and the false anomalies so that the model can make predictive decisions based on information fed back into the model. And the cloud database 90 writes into the anomaly validation table from users confirming true anomalies vs. false positive anomalies.

Embodiments of the present disclosure provide the advantage of being able to dynamically track anomalies across various payment channels and identify patterns thereof, to thereby mitigate erroneous declines more quickly.

According to other embodiments of the present disclosure, additional models can be created at the model training environment 150 to analyze the anomaly patterns along with other data such as the implementation of new mandates or changes that occur on an associated network.

According to yet another embodiment, an ML algorithm may be implemented herein whereby the model training environment 150 collects the anomaly data via the ML feedback loop and trains the model 140 based on root cause data to generate corrective and predictive actions to be implemented, to thereby prevent or minimize the anomaly occurrences.

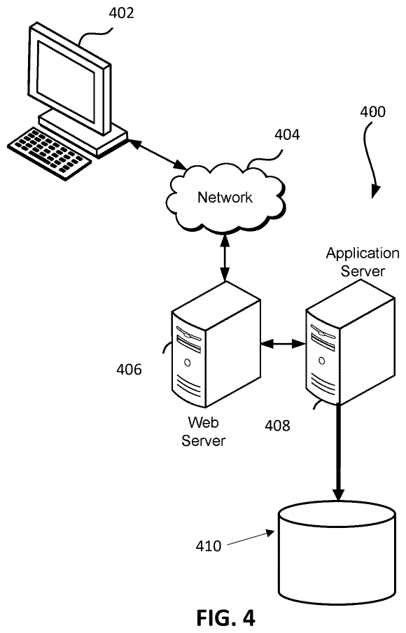

FIG. 4 illustrates an example environment 400 for hosting the data storage pipeline and model training environment 150 in which various embodiments of the present disclosure can be implemented. The environment 400 can be a cloud storage environment. As will be appreciated, although a web-based environment is used for purposes of explanation, different environments may be used, as appropriate, to implement various embodiments.

The environment includes an electronic device 402, which can include any appropriate device operable to send and/or receive requests, messages, or information over an appropriate network 404 and, in some embodiments, convey information back to a user of the device. Examples of such electronic devices 402 include personal computers, cell phones, handheld messaging devices, laptop computers, tablet computers, set-top boxes, personal data assistants, embedded computer systems, electronic book readers, and the like.

The network 404 can include any appropriate network, including an intranet, the Internet, a cellular network, a local area network, a satellite network, or any other such network and/or combination thereof. Components used for such a system can depend at least in part upon the type of network and/or environment selected. Many protocols and components for communicating via such a network are well known and will not be discussed herein in detail.

Communication over the network can be enabled by wired or wireless connections and combinations thereof. In this example, the network 404 includes the Internet and/or other publicly addressable communications network. As the environment includes a web server 406 for receiving requests and serving content in response thereto, although for other networks an alternative device serving a similar purpose could be used as would be apparent to one of ordinary skill in the art.

The illustrative environment includes at least one application server 408 and a data store 410. It should be understood that there can be several application servers, serverless services, layers or other elements, processes, or components, which may be chained or otherwise configured, which can interact to perform tasks such as obtaining data from an appropriate data store. Servers, as used herein, may be implemented in various ways, such as hardware devices or virtual computer systems. In some contexts, servers may refer to a programming module being executed on a computer system.

As used herein, unless otherwise stated or clear from context, the term “datastore” or “data store” refers to any device or combination of devices capable of storing, accessing, and retrieving data, which may include any combination and number of data servers, databases, data storage devices, and data storage media, in any standard, distributed, virtual, or clustered environment.

The application server 408 can include any appropriate hardware, software, and firmware for integrating with the data store 410 as needed. The hardware, software, and firmware may execute aspects of one or more applications for the electronic device 402, handling some or all of the data access and business logic for an application.

The application server 408 may provide access control services in cooperation with the data store 410 and is able to generate content including. The content may include text, graphics, audio, video, and/or other content usable to be provided to the user, which may be served to the user by the web server 406. The content may be served in the form of Hypertext Markup Language (HTML), Extensible Markup Language (XML), JavaScript, Cascading Style Sheets (CSS), JavaScript Object Notation (JSON), and/or another appropriate client-side structured language.

Content transferred to an electronic device 402 may be processed by the electronic device 402 to provide the content in one or more forms including, but not limited to, forms that are perceptible to the user audibly, visually, and/or through other senses. The handling of all requests and responses, as well as the delivery of content between the electronic device 402 and the application server 408, can be handled by the web server 406 using PHP: Hypertext Preprocessor (PHP), Python, Ruby, Perl, Java, HTML, XML, JSON, and/or another appropriate server-side structured language in this example. Further, operations described herein as being performed by a single device may, unless otherwise clear from context, be performed collectively by multiple devices, which may form a distributed and/or virtual system.

The environment, in one embodiment, is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 4. Thus, the depiction of the system illustrated in the example environment 400 in FIG. 4 should be taken as being illustrative in nature and not limiting to the scope of the disclosure.

Where a system includes computerized devices, each such device can include hardware elements that may be electrically coupled via a bus, the elements including, for example, at least one central processing unit (CPU) or processor, at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (RAM) or read-only memory (ROM), as well as removable media devices, memory cards, flash cards, etc.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium (CRM) may be described as a single medium and includes a single medium or multiple media, such as a centralized or distributed database, and/or associated caches and servers that store one or more sets of instructions. The term CRM may also include any medium capable of storing, encoding or carrying a set of instructions for execution by a processor or that cause a computer system to perform any one or more of the embodiments disclosed herein.

The CRM may comprise a non-transitory CRM or media and/or comprise a transitory CRM or media. In a particular non-limiting, exemplary embodiment, the CRM can include a solid-state memory such as a memory card or other package that houses one or more non-volatile read-only memories.

Further, the CRM can be a random-access memory or other volatile re-writable memory. Additionally, the CRM can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein.

Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure.

Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A system for identifying anomaly patterns for card transactions within a consumer banking environment within a cloud environment, the system comprising:
a data pipeline receiving card transaction data from a transaction middleware system;
a transaction collecting module configured to receive the card transaction data and read selected card transactions through a datahose application;
a data pipeline data lake configured to receive the datahose application written in real-time;
a bridge configured to perform a scanning operation to detect when raw data has been input into a data pipeline data lake, and to trigger a partitioning operation when detected;
a data processing module configured to process the raw data in real-time by detecting card transaction declines within the raw data and identifying in real-time, via a machine learning model, anomaly patterns associated with the card transaction declines detected for generation of at least one graphical illustration associated with the anomaly patterns identified to be accessible via a user interface.

2. The system of claim 1, wherein the processing module is further configured to:
perform the partitioning operation to sort the raw data received in order to determine a partition location of any anomalies of the card transactions, wherein the processed data is stored within a cloud database and retrievable in real-time via a machine learning feedback loop by a user at the user interface for displaying the anomaly patterns.

3. The system of claim 1, wherein the anomaly patterns include historical and active anomaly data.

4. The system of claim 1, the stored, processed data is sent through the data pipeline for the data to be consumed by the machine learning model in real-time once placed in a model database of the model.

5. The system of claim 1, wherein the bridge is configured to initiate an alert to be sent to the user at the user interface in real-time when anomaly data is written to the model database.

6. The system of claim 1, further comprising a failure processing module configured to resend processed data back to a different prefix within the data pipeline data lake when a processing failure has occurred at the data processing module instead of storing the processed data.

7. The system of claim 6, further comprising a recon processing module configured to validate the data in the data pipeline data lake by re-running the raw data at the data pipeline data lake to determine whether there are any missed anomalies.

8. The system of claim 7, further comprising a model training environment configured to receive card transactions directly from the transaction middleware system and to dynamically load data associated with the card transactions and the processed data from the data pipeline data lake and storing as historical data within the model training environment.

9. The system of claim 8, wherein the model training environment comprises a model repo module within the machine learning feedback loop, and the model repo module is configured to pull and replay models from which the model training environment and pushes the model into the datahose application.

10. The system of claim 1, wherein identification of anomaly patterns can be performed using an anomaly algorithm.

11. The system of claim 10, wherein the anomaly algorithm comprises at least one of a z-score, fast z-score, an exponential weighted moving average model z-score, a median absolute deviation z-score and a seasonal and trend decomposition using Loess z-score.

12. A method for identifying anomaly patterns for card transactions within a consumer banking environment, the method comprising:
retrieving, card transaction data;
filtering and storing the card transaction data as raw data;
processing the raw data in real-time, by detecting card transaction declines within the raw data;
identifying in real-time, via a machine learning model, anomaly patterns associated with the card transaction declines detected; and
generating at least one graphical illustration associated with the anomaly patterns identified, to be accessible via a user interface.

13. The method of claim 12, wherein the method is performed in a cloud environment.

14. The method of claim 13, wherein the processed data is stored within a cloud database and retrieved via a machine learning feedback loop by a user at a user interface, for displaying the anomaly patterns associated with transactional data.

15. The method of claim 14, wherein the anomaly patterns include historical anomaly data and active anomaly data.

16. The method of claim 13, wherein the stored data is sent through a data pipeline for the data to be consumed by the machine learning model in real-time once placed in a model database of the model.

17. The method of claim 16, wherein an alert is sent to the user at the user interface in real-time when anomaly data is written to the model database.

18. The method of claim 17, wherein detected anomalies are validated by the user via the user interface.

19. The method of claim 16, wherein filtering further comprises filtering the card transactions and sending the card transaction data to a transactional journal and the associated transaction data is written to an associated journal database, and
the method further comprises:
publishing the transactional data to a transaction collecting module for real-time processing;
reading select card transactions from the transaction journal and inputting associated card transactional data through a datahose application wherein the data of the datahose application is read and filtered to remove personal identifiable information data and then sent back to the datahose application for further processing, and wherein the datahose application is written in real-time to a data pipeline data lake.

20. (canceled)

21. (canceled)

22. (canceled)

23. (canceled)

24. (canceled)

25. (canceled)

26. A tangible computer-readable medium having stored thereon, computer executable instructions that, if executed by a computing device, cause the computing device to perform a method of identifying anomaly patterns for card transactions within a consumer banking environment, the method comprising:
retrieving, card transaction data;
filtering and storing the card transaction data as raw data;
processing the raw data in real-time, by detecting card transaction declines within the raw data;
identifying in real-time, via a machine learning model, anomaly patterns associated with the card transaction declines detected; and
generating at least one graphical illustration associated with the anomaly patterns identified, to be accessible via a user interface.
